(19) United States
(12) Patent Application Publication
(10) Pub. No.: US 2007/0109140 A1
(43) Pub. Date: May 17, 2007

(54) Smoke detector that plug into electrical outlet

(76) Inventors: George Nicks, Racine, WI (US); Minnie M. Jackson, Racine, WI (US)

Correspondence Address: George Nicks, SR, 3715 Clairmont St., Racine, WI, 53406, US

(21) Appl. No.: 11/152,743

(22) Filed: Nov. 14, 2005

(51) Int. Cl. G08B 17/10; G08B 23/00

(52) U.S. Cl. 340/628; 340/693.1

(57) ABSTRACT

This is an Abstract for an Electrical Smoke Detector that mounts in the ceiling or on the wall near the ceiling. Smoke detector would be installed at a height that would meet The Fire Department code specification. This would be mounted on an amateur plate with a breaker switch (6×6) with a snap close casing. This system would be equipped with a 9 volt battery backup in case the electricity failed. There would be a red tester button and a low battery indicator that sounds to warn that battery needs changing. There would be a build in sensor that would detect smoke or heat. Person with older homes could get a grant thru CAP to install the new smoke detectors.

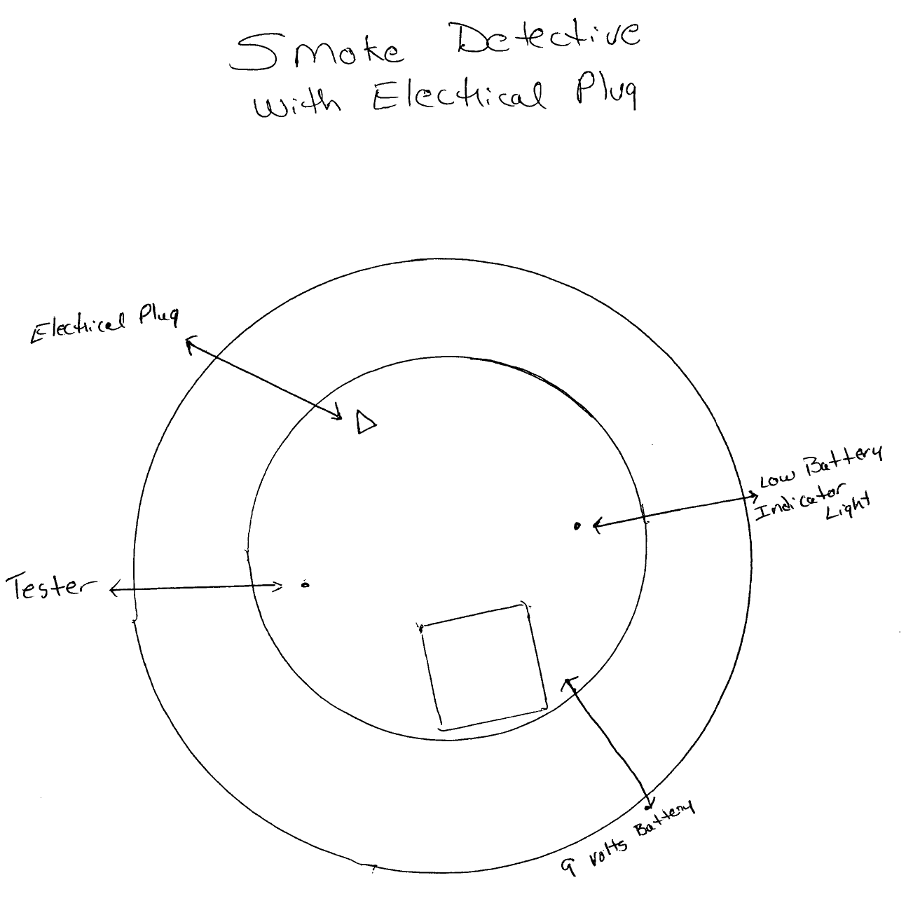

### BRIEF DESCRIPTION OF INVENTION

This would be a smoke detector that would plug into an electrical outlet. There would be a place for a battery as a backup. If the electricity goes out the battery would kick in. There would be an alarm that would sound at any sign of a fire, smoke, and heat sensitive. There would also be an annoying warning signal when the backup battery is low.

1. This application claims title to nonprovisional application Ser. No. 11/152,743, filed Jun. 15, 2005 and titled Electric Smoke Detector. I/we feel this unit would save lives because owners of these units would not have to worry so much about batteries being removed and used for something else and remembering to replace the batteries as much.
